(19) United States
(12) Patent Application Publication
(10) Pub. No.: US 2009/0234519 A1
(43) Pub. Date: Sep. 17, 2009

(54) JOINING A CIVIL TRAJECTORY AND A MILITARY TRAJECTORY

(75) Inventors: Francois HOOFD, Toulouse (FR); Emmanuel Dewas, Toulouse (FR)

Correspondence Address: LOWE HAUPTMAN & BERNER, LLP, 1700 DIAGONAL ROAD, SUITE 300, ALEXANDRIA, VA, 22314, US

(73) Assignee: THALES, Neuilly/Sur/Seine (FR)

(21) Appl. No.: 12/400,823

(22) Filed: Mar. 10, 2009

(30) Foreign Application Priority Data
Mar. 11, 2008 (FR) 08 01323

(51) Int. Cl. G06F 19/00

(52) U.S. Cl. 701/4

(57) ABSTRACT

The present invention relates to a trajectory calculation method making it possible to join a so-called military trajectory (Tm1) from a so-called civil trajectory (Tc1) and, reciprocally, to join a so-called civil trajectory (Tc2) from a so-called military trajectory (Tm1). For example, if the flight of an aircraft (A) must comply with civil standards over part of its flight plan and then perform a mission comprising tactical constraints before returning to a civil trajectory, the method described in the present patent application is entirely suitable.

### RELATED APPLICATIONS

The present application is based on, and claims priority from, French Application No. 08/01323, filed Mar. 11, 2008, the disclosure of which is hereby incorporated by reference herein in its entirety.

### FIELD OF THE INVENTION

The present invention relates to a trajectory calculation method making it possible to join a so-called military trajectory from a so-called civil trajectory and, vice versa, to join a so-called civil trajectory from a so-called military trajectory.

### BACKGROUND OF THE INVENTION

Specifically, flight management systems, commonly referred to by the acronym FMS, or mission preparation systems, generally make a distinction between “civil” trajectories and “military” trajectories. Thus, the constraints related to the following of a civil trajectory are not the same as those related to the following of a military trajectory.

Civil standards, which apply to civil trajectories, impose safety constraints on the speed, the ground height or the turning radius for example. Conversely, during a mission in a theatre of operations, constraints of a tactical nature are imposed on aircraft. For example, it may be obligatory to fly at very low altitude, at very high speed, or to perform very tight turns.

Now, aircraft frequently take off and perform part of their mission on a civil trajectory before reaching the theatre of operations and switching to a military trajectory for a tactical mission, then finally rejoining the civil trajectory for the return flight.

In this case, the switch from the civil trajectory to the military trajectory and then from the military trajectory to the civil trajectory exhibits discontinuities at the trajectory calculation systems level and at the FMS level.

Currently, no method allows automated or systematic calculation of the transition between civil and military trajectories.

Specifically, today, during flight preparation or during in-flight rerouting, the crew record their flight plan on the FMS of the aircraft. This FMS comprises various modules allowing it to calculate the trajectories corresponding to the flight plan provided. The functions of a standard FMS are described in the ARINC 702 standard and comprise:
a location module allowing geo-location of the aircraft;
a flight plan;
a navigation database making it possible to construct geographical routes;
a performance database, containing the aerodynamic characteristics and the parameters of the engine of the aircraft;
a lateral trajectory calculation module making it possible to construct a continuous trajectory on the basis of the points of the flight plan, and complying with the performance of the aircraft as well as any confinement constraints;
a prediction module making it possible to construct a vertical profile optimized on the lateral trajectory;
a guidance module, so as to guide the aircraft in the lateral and vertical planes;
a data link making it possible to communicate with the control centres and the other aircraft.

Within the framework of a tactical mission for example, there may be a flight plan section in which civil constraints and tactical constraints overlap.

Generally, in this case a point of the military trajectory, from which the aircraft will have to follow the military trajectory, and a point from which the aircraft will have to join the civil trajectory, are chosen.

Currently, within prior state FMSs, no method of calculating a transition trajectory between civil and military trajectories exists. The transitions are therefore discontinuous.

It is in order to alleviate this drawback that the invention proposes a trajectory calculation method aimed at allowing an aircraft to join a military trajectory from a civil trajectory, and vice versa, based on the positioning of a capture point and the determination of transition “legs”. The term “leg” refers to an object particular to the FMS domain, consisting of a path and of a termination.

### SUMMARY OF THE INVENTION

For this purpose, the subject of the invention is a trajectory calculation method aimed at allowing an aircraft to join a secondary trajectory exhibiting secondary characteristics from a primary trajectory exhibiting primary characteristics, the primary and secondary characteristics possibly being termed “civil” or “military”, and exhibiting different constraints in terms at least of ranges of values permitted for the speed, the said primary and secondary characteristics being subject to the said different constraints, the secondary trajectory exhibiting an entry point starting from which the aircraft absolutely must follow the secondary trajectory according to the secondary characteristics, characterized in that the said trajectory calculation method comprises at least the following steps:
the choice of a capture point at which the aircraft must have captured the secondary characteristics of the secondary trajectory so that the said aircraft can follow the secondary trajectory starting from the entry point according to the secondary characteristics,
the calculation of a trajectory for joining the secondary trajectory from the primary trajectory comprising at least one first transition leg.

The primary trajectory can for example be a civil trajectory, exhibiting civil characteristics.

The secondary trajectory can for example be a military trajectory, exhibiting military characteristics.

Advantageously, the military trajectory can comprise a low-altitude flight phase.

Advantageously, the first transition leg is one of the legs defined by the ARINC 424 standard: IF; CF; DF; TF; AF; RF; VI; CI; VA; CA; FA; VD; CD; VR; CR; FC; FD; VM; FM; HA; HA; HF; HM; PI.

Advantageously, the first transition leg is a CF leg.

In an exemplary implementation, the trajectory calculation method according to the invention comprises the following steps:
the choice of the capture point on the secondary trajectory backwards from the entry point,
the definition of the first transition leg having the capture point as termination point and the course of the secondary trajectory at the capture point as arrival course,
the calculation of a trajectory for joining the first transition leg from the primary trajectory and according to the primary characteristics.

In another exemplary implementation, the trajectory calculation method according to the invention can furthermore comprise a phase of joining a tertiary trajectory, that may possibly be identical to the primary trajectory, from the secondary trajectory, the tertiary trajectory exhibiting tertiary characteristics and a return point, starting from which the aircraft absolutely must follow the said tertiary trajectory according to the tertiary characteristics, characterized in that the said method comprises the following steps:
the determination of an exit point, situated on the secondary trajectory, at which the aircraft must have captured the tertiary characteristics of the tertiary trajectory,
the definition of a second transition leg having the exit point as termination point,
the calculation of a trajectory for joining the second transition leg from the secondary trajectory and according to the secondary characteristics,
the definition of a third transition leg having the return point as termination point and the course of the tertiary trajectory at the return point as arrival course,
the calculation of a trajectory for joining the third transition leg from the exit point and according to the tertiary characteristics.

The tertiary trajectory can for example be a civil trajectory, exhibiting civil characteristics.

Advantageously, the second transition leg is one of the legs defined by the ARINC 424 standard: IF; CF; DF; TF; AF; RF; VI; CI; VA; CA; FA; VD; CD; VR; CR; FC; FD; VM; FM; HA; HA; HF; HM; PI.

Advantageously, the third transition leg is one of the legs defined by the ARINC 424 standard: IF; CF; DF; TF; AF; RF; VI; CI; VA; CA; FA; VD; CD; VR; CR; FC; FD; VM; FM; HA; HA; HF; HM; PI.

Advantageously, the second transition leg is a DF leg.

Advantageously, the third transition leg is a CF leg.

Advantageously, the third transition leg is a TF leg between the exit point and the return point.

Advantageously, a flight management system can comprise means suitable for executing the trajectory calculation method according to the invention.

Still other objects and advantages of the present invention will become readily apparent to those skilled in the art from the following detailed description, wherein the preferred embodiments of the invention are shown and described, simply by way of illustration of the best mode contemplated of carrying out the invention. As will be realized, the invention is capable of other and different embodiments, and its several details are capable of modifications in various obvious aspects, all without departing from the invention. Accordingly, the drawings and description thereof are to be regarded as illustrative in nature, and not as restrictive.

### BRIEF DESCRIPTION OF THE DRAWINGS

The present invention is illustrated by way of example, and not by limitation, in the figures of accompanying drawings, wherein elements having the same reference numeral designations represent like elements throughout and wherein:

FIG. 1: an example of a section of a flight plan including a primary civil trajectory and a secondary military trajectory;

FIG. 2: the illustration of the positioning of a capture point at which the characteristics of the military trajectory must be captured, with a view to joining this trajectory, in accordance with the method according to the invention;

FIG. 3: the diagram of a transition trajectory making it possible to join the military trajectory from the civil trajectory via the capture point in accordance with the method according to the invention;

FIG. 4: the illustration of the positioning of an exit point at which the characteristics of the civil trajectory must be captured, with a view to joining this trajectory, in compliance with the method according to the invention;

FIG. 5: the diagram of a transition trajectory making it possible to join the civil trajectory from the military trajectory via the exit point in accordance with the method according to the invention.

### DETAILED DESCRIPTION OF THE INVENTION

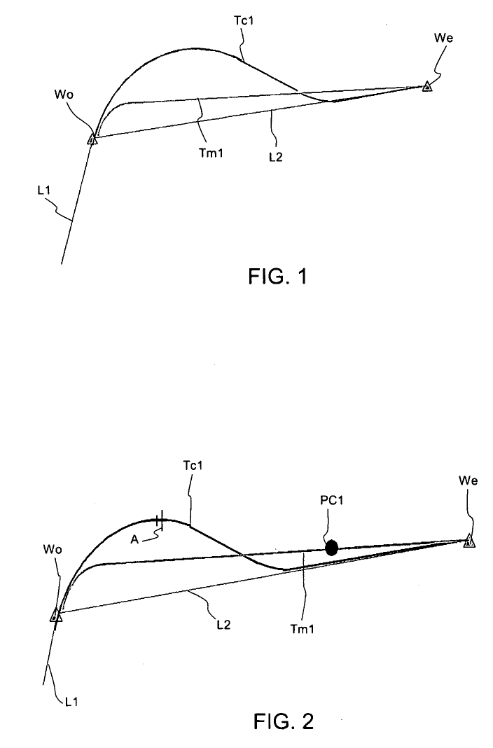

FIG. 1 presents a diagram with two trajectories with the different characteristics. Of interest is the case where an aircraft must join the secondary trajectory Tm1 from the primary trajectory Tc1. In this example, it is considered that the primary trajectory Tc1 is civil while the secondary trajectory Tm1 is military.

In a basic manner, a flight plan can be considered to be a succession of waypoints Wo, We . . . with which are associated characteristics such as the speed, the altitude and the heading of the aircraft at the said waypoint. These waypoints Wo, We . . . are generally linked by legs L1, L2 . . . , that the aircraft is presumed to follow as closely as possible. The flight management system FMS is charged with formulating the trajectories Tc1, Tm1 . . . . which will allow the aircraft to comply with its flight plan. These trajectories are subject to certain constraints, in terms of ranges of values permitted for the altitude, speed, roll, etc. These constraints depend on the type of mission, the environment, etc. They may be so-called civil or military. In the first case, the constraints are essentially related to safety and significant margins are taken with respect to the risks related to the topology of the terrain or to the performance of the aeroplane notably. Civil standards defined by State bodies govern these constraints. In the second case, the tactical constraints are essential. The safety margins are generally reduced so as to be able to accomplish the mission.

Thus, in the illustration of FIG. 1, it is noted that to travel from the waypoint Wo to the waypoint We, the civil trajectory Tc1 and the military trajectory Tm1 are very different. On the military trajectory Tm1, it is notably possible to perform tighter turns.

In the example considered here, the aircraft absolutely must have travelled on the military trajectory Tm1 at the entry point We. The last waypoint of the flight plan overflown on the civil trajectory Tc1 is the point Wo, the end of the leg L1. The transition is therefore performed at the level of the leg L2.

The idea is to ensure continuous guidance of the aircraft. For this purpose, a single and continuous trajectory must be defined. However, the construction of the join between the trajectories Tc1 and Tm1 is in no way obvious a priori. This is the subject of the invention.

FIG. 2 illustrates the first phase of the method of calculating a transient trajectory between trajectories with different characteristics according to the invention.

This first phase consists in positioning a capture point PC1 starting from which the aircraft A must have captured the characteristics of the military trajectory Tm1, in terms of speed, altitude, etc., so as to be able to ideally follow the said military trajectory Tm1 starting from the entry point We.

A point PC1 must therefore be chosen on the military trajectory Tm1, backwards from the entry point We, where it is necessary to capture the flight characteristics complying with the military framework of the trajectory Tm1. To position this point PC1, a criterion for joining the military trajectory Tm1 is chosen. For example, it may be desired to capture the military trajectory Tm1 at a certain altitude, typically, in the case where the military trajectory Tm1 were to consist of a tactical flight at very low altitude.

The criterion for choosing the point PC1 can also be a speed to be reached on the military trajectory Tm1, etc.

When this capture point PC1 is positioned, the method continues with the calculation of a transition trajectory making it possible to join the capture point PC1, and then the military trajectory Tm1.

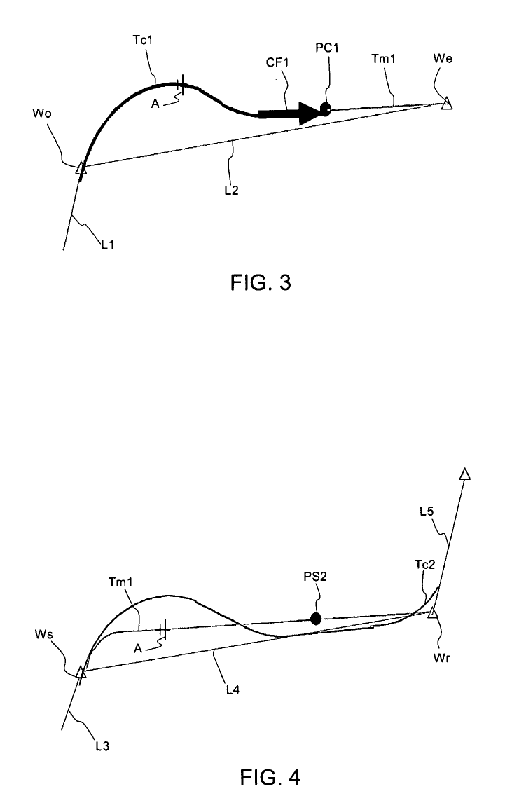

FIG. 3 represents the process of constructing this transition trajectory.

For this purpose, a leg aimed at bringing the aircraft A to the point PC1 is firstly defined. Various types of legs exist. Thus, the ARINC 424 standard catalogues 23 types of legs, as a function of their characteristics. Among the principal legs may be cited the legs:
CF, signifying Course to a Fix, characterized by a fixed termination point, that is to say a waypoint constituting the end of the said leg, and an arrival course, which corresponds to the course of the aircraft A at the termination point, the course of the aircraft A being the angle that the aircraft A makes with respect to North;
TF, signifying Track between two Fixes, a leg consisting of a direct route between two fixed points, therefore exhibiting an origin point and a termination point;
DF, signifying Direct to a Fix, consisting in joining up, in a direct line, with a fixed point constituting the termination point of the said leg.

The other legs of the ARINC 424 standard are presented briefly in the following table:

| | Name in the ARINC 424 | |
|---|---|---|
| Leg | standard | Meaning |
| IF | Initial Fix | Fixed initial point on the ground |
| AF | Arc DME to Fix | Defines a circular arc around a specified |
| | | remote DME beacon, with an aperture limit |
| RF | Radius to a Fix | Defines a circular arc between two fixed points |
| | | (the 1^{st} point being the fixed point of the |
| | | previous leg), on a centre of the fixed circle |
| VI | Heading to Intercept | Defines a heading to be followed up to |
| | | interception of the next leg |
| CI | Course to Intercept | Defines a route to be followed up to |
| | | interception of the next leg |
| VA | Heading to Altitude | Defines a heading to be followed up to a given |
| | | altitude |
| CA | Course to Altitude | Defines a route to be followed up to a given |
| | | altitude |
| FA | Fix to Altitude | Defines a route to be followed, starting from a |
| | | fixed point, up to a given altitude |
| VD | Heading to DME Distance | Defines a heading to be followed up to |
| | | interception of a specified DME arc |
| CD | Course to DME Distance | Defines a route to be followed up to |
| | | interception of a specified DME arc |
| VR | Heading to Radial | Defines a heading to be followed up to |
| | | interception of a specified radial |
| CR | Course to Radial | Defines a route to be followed up to |
| | | interception of a specified radial |
| FC | Track from Fix to Distance | Defines a route to be followed, starting from a |
| | | fixed point, over a specified distance |
| FD | Track from Fix to DME | Defines a route to be followed, starting from a |
| | Distance | fixed point, until it intercepts a DME arc |
| | | (specified DME distance) |
| VM | Heading to Manual | Defines a heading without termination (infinite |
| | | half-line) |
| FM | Fix to Manual | Defines a route, starting from a fixed point, |
| | | without termination (infinite half-line) |
| HA | Hippodrome to Altitude | Hippodrome circuit, with altitude exit condition |
| | Termination | |
| HF | Hippodrome to Fix Termination | Hippodrome circuit, with a single lap |
| HM | Hippodrome to Manual | Manual hippodrome circuit, without exit |
| | Termination | condition |
| PI | Fix to Manual | Outbound procedure defined by an outbound |
| | | route starting from a fixed point, followed by a |
| | | half-lap, and interception of the initial outbound |
| | | route for the return |

In the example illustrated in FIG. 3, a CF leg is constructed, denoted CF1, having the capture point PC1 as termination point and the course of the military trajectory Tm1 at the capture point PC1 as arrival course.

The trajectory is thereafter recalculated by using civil algorithms to join the leg CF1. Having reached the leg CF1, the aircraft A has joined the military trajectory Tm1 that it will definitely follow starting from the waypoint We.

The same problem arises when the aircraft A gets ready to leave the military trajectory Tm1 so as to return to the civil trajectory Tc1 or join another civil trajectory Tc2, and the construction of the transition from the trajectory Tm1 to the trajectory Tc1 or Tc2 is similar to the transition from the trajectory Tc1 to the trajectory Tm1, described with the aid of FIGS. 1 to 3.

Thus, FIG. 4 presents by way of example the first phase of joining the tertiary trajectory Tc2, the civil trajectory, from the secondary trajectory Tm1, the military trajectory. It should be noted that the tertiary trajectory Tc2 can actually be in reality the primary trajectory Tc1.

The last point overflown on the military trajectory Tm1 is the waypoint Ws, the end of the leg L3; the transition is performed at the level of the leg L4 so that the aircraft A has joined the civil trajectory Tc2 at the point Wr, the origin of the leg L5.

This therefore involves positioning an exit point PS2, at which the aircraft A must absolutely have captured the civil characteristics of the civil trajectory Tc2, so that the aircraft A is able to follow the civil trajectory Tc2 as from the waypoint Wr. The point PS2 is chosen on the military trajectory Tm1 and therefore indeed constitutes the exit point of the said trajectory Tm1.

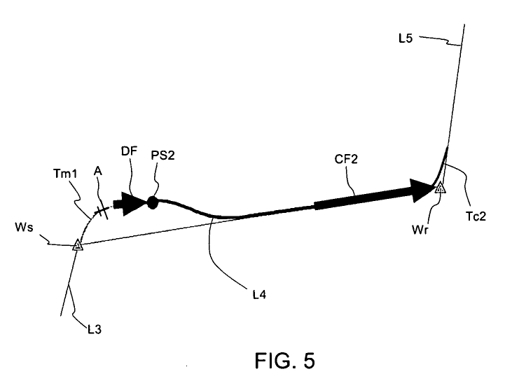

FIG. 5 illustrates the next step, which consists in joining up with the exit point PS2 and then the trajectory Tc2. To join the point PS2, a leg having the point PS2 as termination point is defined, for example a DF leg, denoted DF in the figure.

A CF leg for example, denoted CF2, is thereafter defined having the waypoint Wr as termination point at which the aircraft A must absolutely have joined the trajectory Tc2, and the course of the original leg L4 as arrival course, the latter generally being a TF leg, plotted between the waypoints Ws and Wr.

Finally, a transition trajectory is recalculated complying with the characteristics of the tertiary trajectory Tc2, that is to say here using the civil algorithms, so as to join the leg CF2, after passing through the exit point PS2.

The aircraft A is then able to follow the tertiary trajectory Tc2 from the waypoint Wr.

It should be noted that the procedure for joining the tertiary trajectory Tc2 from the secondary trajectory Tm1 can be transposed identically for joining a secondary trajectory from a primary trajectory. The examples described through the appended figures are illustrative.

To summarize, the principal advantage of the invention is to propose an original trajectory calculation method aimed at allowing the joining of trajectories exhibiting distinct constraints. For example, if the flight of an aircraft A must comply with civil standards over part of its flight plan and then perform a mission comprising tactical constraints before returning to a civil trajectory, the method described in the present patent application is entirely suitable.

It will be readily seen by one of ordinary skill in the art that the present invention fulfils all of the objects set forth above. After reading the foregoing specification, one of ordinary skill in the art will be able to affect various changes, substitutions of equivalents and various aspects of the invention as broadly disclosed herein. It is therefore intended that the protection granted hereon be limited only by definition contained in the appended claims and equivalents thereof.

1-15. (canceled)

16. A trajectory calculation method aimed at allowing an aircraft to join a secondary trajectory exhibiting secondary characteristics from a primary trajectory exhibiting primary characteristics, the primary and secondary characteristics being termed civil or military, and exhibiting different constraints in terms at least of ranges of values permitted for the speed, the primary and secondary characteristics being subject to the different constraints, the secondary trajectory exhibiting an entry point starting from which the aircraft absolutely must follow the secondary trajectory according to the secondary characteristics, the trajectory calculation method comprising the following steps:
the choice of a capture point at which the aircraft must have captured the secondary characteristics of the secondary trajectory so that the aircraft can follow the secondary trajectory starting from the entry point according to the secondary characteristics,
the calculation of a trajectory for joining the secondary trajectory from the primary trajectory comprising at least one first transition leg.

17. The trajectory calculation method according to claim 16, wherein the primary trajectory is a civil trajectory, exhibiting civil characteristics.

18. The trajectory calculation method according to claim 16, wherein the secondary trajectory is a military trajectory, exhibiting military characteristics.

19. The trajectory calculation method according to claim 18, wherein the military trajectory comprises a low-altitude flight phase.

20. The trajectory calculation method according to claim 16, wherein the first transition leg is one of the legs defined by the ARINC 424 standard: IF; CF; DF; TF; AF; RF; VI; CI; VA; CA; FA; VD; CD; VR; CR; FC; FD; VM; FM; HA; HA; HF; HM; PI.

21. The trajectory calculation method according to claim 16, wherein the first transition leg is a CF leg.

22. The trajectory calculation method according to claim 16, wherein the said trajectory calculation method comprises the following steps:
the choice of the capture point on the secondary trajectory backwards from the entry point,
the definition of the first transition leg having the capture point as termination point and the course of the secondary trajectory at the capture point as arrival course,
the calculation of a trajectory for joining the first transition leg from the primary trajectory and according to the primary characteristics.

23. The trajectory calculation method according to claim 21, wherein the said trajectory calculation method comprises the following steps:
the choice of the capture point on the secondary trajectory backwards from the entry point,
the definition of the first transition leg having the capture point as termination point and the course of the secondary trajectory at the capture point as arrival course,
the calculation of a trajectory for joining the first transition leg from the primary trajectory and according to the primary characteristics.

24. The trajectory calculation method according to claim 23, furthermore comprising a phase of joining a tertiary trajectory, that may possibly be identical to the primary trajectory, from the secondary trajectory, the tertiary trajectory exhibiting tertiary characteristics and a return point, starting from which the aircraft absolutely must follow the said tertiary trajectory according to the tertiary characteristics, wherein the said method comprises the following steps:
the determination of an exit point, situated on the secondary trajectory, at which the aircraft must have captured the tertiary characteristics of the tertiary trajectory,
the definition of a second transition leg having the exit point as termination point,
the calculation of a trajectory for joining the second transition leg from the secondary trajectory and according to the secondary characteristics,
the definition of a third transition leg having the return point as termination point and the course of the tertiary trajectory at the return point as arrival course
the calculation of a trajectory for joining the third transition leg from the exit point and according to the tertiary characteristics.

25. The trajectory calculation method according to claim 24, wherein the tertiary trajectory is a civil trajectory, exhibiting civil characteristics.

26. The trajectory calculation method according to claim 24, wherein the second transition leg is one of the legs defined by the ARINC 424 standard: IF; CF; DF; TF; AF; RF; VI; CI; VA; CA; FA; VD; CD; VR; CR; FC; FD; VM; FM; HA; HA; HF; HM; PI.

27. The trajectory calculation method according to claim 24, wherein the third transition leg is one of the legs defined by the ARINC 424 standard: IF; CF; DF; TF; AF; RF; VI; CI; VA; CA; FA; VD; CD; VR; CR; FC; FD; VM; FM; HA; HA; HF; HM; PI.

28. The trajectory calculation method according to claim 26, wherein the third transition leg is one of the legs defined by the ARINC 424 standard: IF; CF; DF; TF; AF; RF; VI; CI; VA; CA; FA; VD; CD; VR; CR; FC; FD; VM; FM; HA; HA; HF; HM; PI.

29. The trajectory calculation method according to claim 24, wherein the second transition leg is a DF leg.

30. The trajectory calculation method according to claim 24, wherein third transition leg is a CF leg.

31. The trajectory calculation method according to claim 24, wherein the third transition leg is a TF leg between the exit point and the return point.

32. The trajectory calculation method according to claim 28, wherein the second transition leg is a DF leg.

33. The trajectory calculation method according to claim 28, wherein the third transition leg is a CF leg.

34. The trajectory calculation method according to claim 28, wherein the third transition leg is a TF leg between the exit point and the return point.
